(19) United States
(12) Patent Application Publication
(10) Pub. No.: US 2022/0134402 A1
(43) Pub. Date: May 5, 2022

(54) PUNCHING ABNORMALITY DETECTION SYSTEM

(71) Applicant: Shenzhen Fugui Precision Ind. Co., Ltd., Shenzhen (CN)

(72) Inventors: PENG XU, Shenzhen (CN); CHEN-YANG MA, Shenzhen (CN); JIAN-SHE FENG, Shenzhen (CN); LIU-QING ZHANG, Shenzhen (CN)

(21) Appl. No.: 17/149,492

(22) Filed: Jan. 14, 2021

(30) Foreign Application Priority Data
Oct. 30, 2020 (CN) 202011197567.4

(51) Int. Cl. B21C 51/00; G01N 29/42

(52) U.S. Cl. CPC B21C 51/00; G01N 29/42

(57) ABSTRACT

A punching abnormality detection system, comprising: a punch, generating a vibration signal when working; an ultrasonic sensor, fixed on the punch and configured to convert the vibration signal into a voltage response signal; a data acquisition device, electrically connected to the ultrasonic sensor, configured to collect the voltage response signal in real time, generate a monitoring envelope curve, and analyze whether the voltage response curve deviates from the monitoring envelope curve; when the voltage response curve exceeds the monitoring envelope curve, the data acquisition device determine that the punch works abnormally, and an abnormal signal is output, thereby predicting production interruption caused by equipment abnormality during the production process and improving production quality.

### CROSS-REFERENCE TO RELATED APPLICATIONS

This application claims priority to Chinese Patent Application No. 202011197567.4 filed on Oct. 30, 2020, the contents of which are incorporated by reference herein.

### FIELD

The subject matter herein generally relates to the field of sensors, and particularly to an ultrasonic sensor.

### BACKGROUND

In industrial production, abnormalities in production equipment, such as punching equipment, often occur, which may cause abnormal product batches and interrupt production. Therefore, it is necessary to monitor the long-term vibration parameters of the production equipment, so as to predict the production interruption caused by the abnormal equipment during the production process.

### BRIEF DESCRIPTION OF THE DRAWINGS

Implementations of the present technology will now be described, by way of example only, with reference to the attached figures.

FIG. 1 is a schematic structural diagram of an embodiment of an ultrasonic sensor of the present invention.

FIG. 2 is a schematic diagram of modules of an embodiment of the punching abnormality detection system of the present invention.

FIG. 3 is a schematic diagram of the monitoring envelope curve of the present invention.

FIG. 4 is a schematic diagram of a data acquisition device extracting effective signals of the voltage response signal of the present invention.

FIG. 5 is a schematic diagram of the data acquisition device performing high frequency removal processing on effective signals of the present invention.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

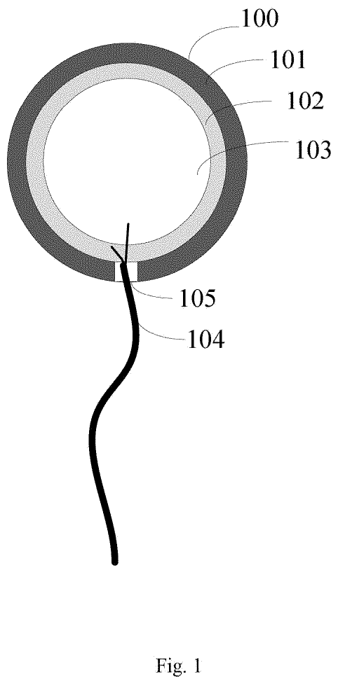

FIG. 1 illustrates the schematic structural diagram of an embodiment of an ultrasonic sensor 10 of the present invention. In at least one embodiment, the ultrasonic sensor 10 includes a shell 100, a cover sheet 101, a copper foil 102, a piezoelectric chip 103 and a cable 104. The ultrasonic sensor 10 is installed on a test device to detect a vibration signal of the test device and convert the vibration signal into a voltage response signal.

In at least one embodiment, one end of the shell 100 is open, and the other end of the shell 100 is a closed surface. The closed surface includes an inner bottom surface. The cover sheet 101 is matched with the open end of the shell 100 and bonded to the open end of the shell 100. The copper foil 102 includes an upper surface and a lower surface, and the lower surface of the copper foil 102 is bonded to the inner bottom surface of the closed surface of the shell 100. The piezoelectric chip 103 includes an upper surface and a lower surface, and the lower surface of the piezoelectric chip 103 is bonded to the upper surface of the copper foil 102. When the test device vibrates, the piezoelectric chip 103 converts the vibration signal into a voltage response signal. In at least one embodiment, the piezoelectric chip 103 is a ceramic chip. The cable 104 includes a positive electrode and a negative electrode. The positive electrode of the cable 104 is welded on the upper surface of the piezoelectric chip 103, and the negative electrode of the cable 104 is welded on the upper surface of the copper foil 102. The cable 104 is configured to connect to an external detection device and transmit the voltage response signal to the external detection device. The external detection device may be, but is not limited to, an oscilloscope, a network analyzer and other detection devices. When the test device continues to work, the cable 104 outputs a continuous voltage response signal curve. When the voltage response curve deviates from a monitoring envelope curve range, the test device works abnormally.

In at least one embodiment, the shell 100 includes a groove 105 configured to lead out the cable 104.

In at least embodiment, the ultrasonic sensor 10 further includes a lead block (not shown in the figures) arranged between the piezoelectric chip 103 and the cover sheet 101. The lead block is configured to amplify the voltage response signal.

In at least one embodiment, the test device is described by taking a punching device as an example. The vibration signal generated by the punching device during the working process is mainly divided into two situations: a vertical acceleration signal is the main component and an acoustic emission signal at the moment of the punching is the main component. When the component of the vibration signal is mainly the vertical acceleration signal, the punching device uses the ultrasonic sensor 10 to respond to the voltage of the vibration signal perpendicular to the thickness direction to reflect the punching signal. The lead block is arranged on the ultrasonic sensor 10 so that the lead block can apply force to the ultrasonic sensor 10 to amplify the voltage response signal of the ultrasonic sensor 10 during punching. The larger the lead block, the larger the voltage response signal of the piezoelectric chip 103, and the higher the frequency, the larger the voltage response signal of the piezoelectric chip 103.

When the component of the vibration signal is mainly the acoustic emission signal, the smaller the lead block, the larger the voltage response signal of the piezoelectric chip 103. Therefore, when the vibration signal generated during the punching process is mainly composed of the acoustic signal at the moment of the punching, the piezoelectric chip 103 responds optimally without the lead block. Therefore, in practical applications, the ultrasonic sensor 10 can be selected to add or not add lead blocks according to different application scenarios.

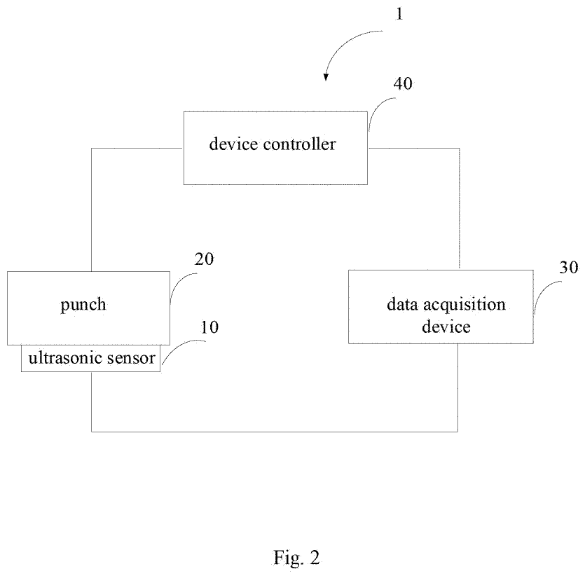

Referring to FIG. 2, FIG. 2 is a schematic diagram of modules of an embodiment of the punching abnormality detection system 1 of the present invention. In at least one embodiment, the punching abnormality detection system 1 includes the ultrasonic sensor 10, a punch 20, and a data acquisition device 30.

In at least one embodiment, the punch 20 includes upper mold and lower mold, and during operation, vibration signals are generated when the upper mold and lower mold impact. The ultrasonic sensor 10 is fixed on the punch 20 and is configured to convert the vibration signal generated by the punch 20 into the voltage response signal. The data acquisition device 30, electrically connected to the ultrasonic sensor 10, is configured to collect the voltage response signal in real time, generate a monitoring envelope curve, and analyze whether the voltage response curve deviates from the monitoring envelope curve. When the voltage response curve exceeds the monitoring envelope curve, it is determined that the punch 20 works abnormally, and an abnormal signal is output.

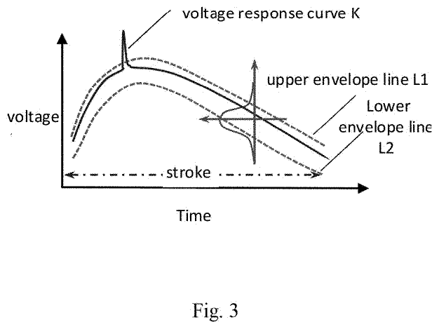

Referring to FIG. 3, FIG. 3 is a schematic diagram of the monitoring envelope curve of the present invention. As shown in FIG. 3, the monitoring envelope curve L includes an upper envelope line L1 and a lower envelope line L2. When the voltage response curve K is between the upper envelope line L1 and the lower envelope line L2, the punch 20 works normally. When the voltage response curve K deviates from the upper envelope line L1, the data acquisition device 30 outputs a first abnormal signal, and when the voltage response curve deviates from the lower envelope L2, the data acquisition device 30 outputs a second abnormal signal.

In at least one embodiment, punching abnormality detection system 1 further includes a device controller 40. The device controller 40 is electrically connected to the punch 20 and the data acquisition device 30, and is configured to control the punch 20 to stop working when the first abnormal signal is received, and send out an alarm when the second abnormal signal is received. Specifically, when the voltage response curve K deviates from the lower envelope curve, the punching product has defects and quality problems; when the voltage response curve K deviates from the upper envelope curve, it indicates that a major failure that endangers the punch 20 or punch mold has occurred, then the device controller 40 controls the punch 20 to stop working. As shown in FIG. 3, the voltage response curve K deviates from the upper envelope L1, at this time, the device controller 40 controls the punch 20 to stop working.

In at least one embodiment, the data acquisition device 30 uses the AI algorithm to generate the monitoring envelope curve according to the voltage response signal. Specifically, the data acquisition device 30 first extracts the effective signal of the voltage response signal; then performs high-frequency removal processing on the effective signal to generate a high-frequency signal; further, extracts time domain features and frequency domain features from the de-high frequency signal; finally, generates the monitoring envelope curve according to the extracted time domain features and frequency domain features. Specifically, the time-frequency domain features mainly include an average value of the waveform, standard deviation, maximum value, minimum value, mean square error, skewness, kurtosis, crest factor, margin factor, crest factor, K factor, etc. PCA-T2 model is used to calculate whether the data features belong to abnormal signal features, or a statistical outlier detection algorithm is used to analyze the original data range, quartile spacing, mean deviation, standard deviation, etc., to generate the monitoring envelope curve and detect abnormal signals in real time. In practical applications, the punching abnormality detection system 1 usually includes a plurality of ultrasonic sensors 10 to realize multi-angle data acquisition.

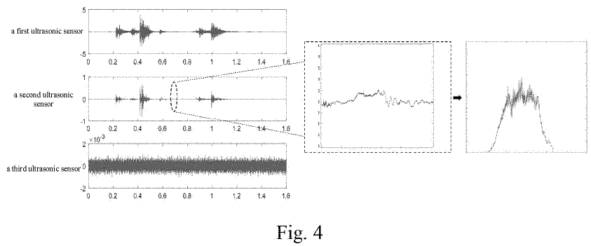

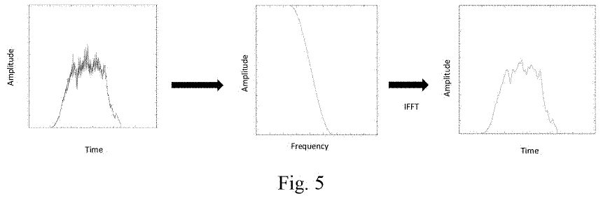

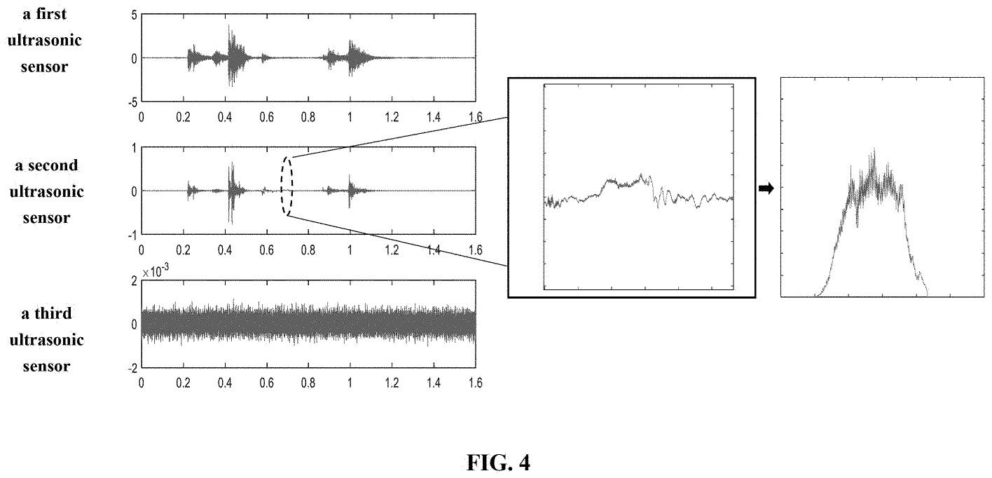

Referring to FIG. 4, FIG. 4 is a schematic diagram of a data acquisition device extracting effective signals of the voltage response signal of the present invention. Taking three ultrasonic sensors 10 as an example. When the punch 20 completes a stroke, the corresponding angle of the electronic cam is 0˜360°. During the punching process, the corresponding electronic cam angle of the upper mold and lower mold is 167˜170°, at this time, an effective signal of impact appears in the second ultrasonic sensor 10. After all the signals of the second ultrasonic sensor 10 are windowed, the effective signal in this part of the dashed frame is extracted for high frequency removal processing.

As shown in FIG. 5, FIG. 5 is a schematic diagram of the data acquisition device performing high frequency removal processing on effective signals of the present invention. As shown in FIG. 5, the effective signal has more glitches, i.e. high frequency component. In order to better display the result, the data acquisition device 30 is further configured to transform the effective signal from a time domain to Fourier transform and multiply by a window that only retains signals below 1 kHz in the frequency domain, and then performs inverse Fourier transform to turn back time domain signal to generate the de-high frequency signal.

Compared with the prior art, the ultrasonic sensor and punching abnormality detection system provided by the embodiments of the present invention monitor the long-term vibration parameters of the production equipment through the ultrasonic sensor, thereby predicting production interruption caused by equipment abnormality during the production process and improving production quality.

Many details are often found in the art such as the other features of a mobile terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A punching abnormality detection system, comprising:
a punch, generating a vibration signal when working;
an ultrasonic sensor, fixed on the punch and configured to convert the vibration signal into a voltage response signal;
a data acquisition device, electrically connected to the ultrasonic sensor, configured to collect the voltage response signal in real time, generate a monitoring envelope curve, and analyze whether the voltage response curve deviates from the monitoring envelope curve; when the voltage response curve exceeds the monitoring envelope curve, the data acquisition device determines that the punch works abnormally, and an abnormal signal is output.

2. The punching abnormality detection system of claim 1, wherein the monitoring envelope curve includes an upper envelope line and a lower envelope line; when the voltage response curve deviates from the upper envelope line, the data acquisition device outputs a first abnormal signal, and when the voltage response curve deviates from the lower envelope, the data acquisition device outputs a second abnormal signal.

3. The punching abnormality detection system of claim 2, further comprising device controller, electrically connected to the punch and the data acquisition device, and configured to control the punch to stop working when the first abnormal signal is received and send out an alarm when the second abnormal signal is received.

4. The punching abnormality detection system of claim 1, wherein the data acquisition device uses AI algorithm to generate the monitoring envelope curve according to the voltage response signal.

5. The punching abnormality detection system of claim 4, wherein the data acquisition device is further configured to:
extract the effective signal of the voltage response signal;
performs high-frequency removal processing on the effective signal to generate a high-frequency signal;
extract time domain features and frequency domain features from the de-high frequency signal;
generate the monitoring envelope curve according to the extracted time domain features and frequency domain features.

6. The punching abnormality detection system of claim 5, wherein the data acquisition device is further configured to transform the effective signal from time domain to Fourier transform and multiply by a window that only retains signals below 1 kHz in frequency domain, and then perform inverse Fourier transform to turn back time domain signal to generate the de-high frequency signal.
